(19) United States
(12) Patent Application Publication
(10) Pub. No.: US 2003/0177232 A1
(43) Pub. Date: Sep. 18, 2003

(54) Load balancer based computer intrusion detection device

(76) Inventor: Chesley B. Coughlin, San Diego, CA (US)

Correspondence Address: KENYON & KENYON, 1500 K STREET, N.W., SUITE 700, WASHINGTON, DC, 20005, US

(21) Appl. No.: 10/098,403

(22) Filed: Mar. 18, 2002

(51) Int. Cl. G06F 15/173; G06F 15/16; G06F 9/00

(52) U.S. Cl. 709/225; 709/205; 709/105

(57) ABSTRACT

A method of detecting intrusion includes receiving a request for data from a client computer to a load balancer and having the load balancer send the request to a first server of a plurality of servers. The load balancer receives a first copy of content, such as a Web page, from the first server in response to the request. The load balancer compares the first copy of content to a master copy of content to determine if the first copy is valid.

### FIELD OF THE INVENTION

One embodiment of the present invention is directed to computer data security. More particularly, one embodiment of the present invention is directed to a load balancer based computer intrusion detection device.

### BACKGROUND INFORMATION

The increasing prevalence of the Internet and other connected networks in people's lives, both for personal and business purposes, have given rise to a data explosion. Large amounts of data from all areas of the world are constantly available to a user with merely access to a personal computer and a communication line.

Unfortunately, the increased use and importance of the Internet has also spawned an increase in the number of people who access data and change data without authorization. These people, often referred to as “hackers”, have been around since the advent of computers. However, because so much data is now available over networks such as the Internet, the opportunities for hackers to perform their deeds has sharply increased in recent years. As a result, the number of unauthorized activities, or “hacks”, has skyrocketed.

One response to hacking incidents is the installation of an intrusion detection device, such as the Gillian G-Server from Gillian Technologies Inc. An intrusion detection device typically sits between the Web server and the router or firewall that connects the Web server to the Internet, and inspects every piece of content that goes out for signs of unauthorized changes. However, this activity adds latency because the data must be redirected to and processed by the intrusion detection device.

Based on the foregoing, there is a need for an improved intrusion detection device that reduces latency and provides other advantages.

### BRIEF DESCRIPTION OF THE DRAWINGS

FIG. 1 is a block diagram of a system in accordance with one embodiment of the present invention.

FIG. 2 is a flow diagram of the functions performed by a load balancer or other devices of the system in accordance with one embodiment of the present invention.

### DETAILED DESCRIPTION

One embodiment of the present invention is a load balancer that compares a master copy of a Web site with the copy received from a Web server. If the copies differ, the load balancer takes proactive action.

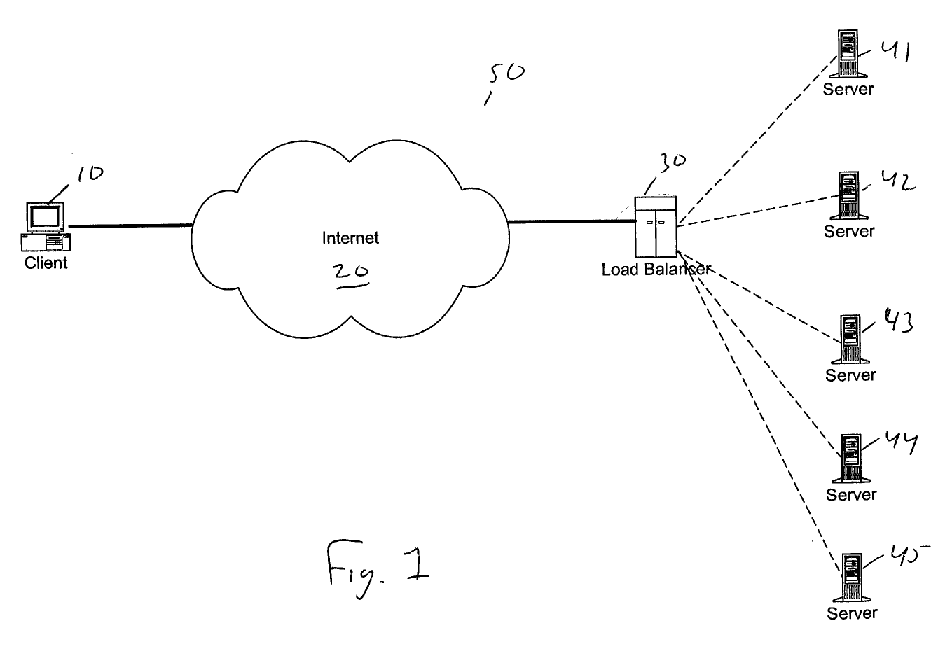

FIG. 1 is a block diagram of a system 50 in accordance with one embodiment of the present invention. System 50 includes the Internet 20 and a client computer 10 that is used to access Internet 20. Client computer 10 can be any known personal computer or other device that includes a Web browser. The Web browser can be the Internet Explorer from Microsoft Corp., or any other type of browser. Client computer 10 accesses Internet 50 through known methods such as through an Internet service provider (not shown).

System 50 further includes a load balancer 30 coupled to servers 41-45. Servers 41-45 form a group of servers that provide the same or similar content to a user and can each respond to the same URL request from a client. Hackers can potentially access servers 41-45 through Internet 50 or through other means and modify or destroy the data stored on servers 41-45.

Load balancer 30 can be any known load balancer that is modified to implement an embodiment of the present invention. Many e-commerce sites and other sites on the Internet employ multiple servers and a load balancer as illustrated in FIG. 1. In essence, a load balancer makes multiple servers look like a single, high-powered network resource to those accessing the site. It does this by selectively forwarding connections to the many servers arrayed behind it in an equitable manner, according to the server's operational health and the nature of the query.

In one embodiment, load balancer 30 is the NetStructure 7180 e-commerce Director from Intel Corp. that has been modified to perform the functions described below. Load balancer 30 includes a processor and a memory or other type of computer readable medium. The memory may be integrated with load balancer 30, or may be remote from load balancer 30 (e.g., a remote memory accessible to load balancer 30 over a network). Stored on the memory in one embodiment is an master copy of all of the Web pages or other content that is stored at servers 41-45. In another embodiment, only a subset of the Web pages stored at servers 41-45 is stored on the memory of load balancer 30. In one embodiment, the master copy may include a template that defines a range of dynamic Web content.

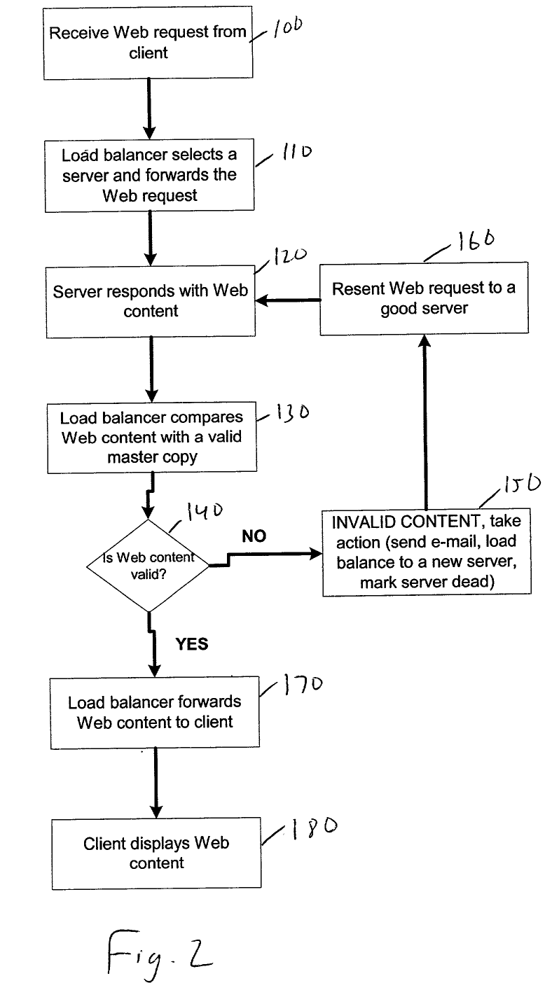

FIG. 2 is a flow diagram of functions performed by load balancer 30 or other devices of system 50 in accordance with one embodiment of the present invention. These functions are performed by load balancer 30 in addition to the typical load balancer functions.

In one embodiment, the functions are implemented by software stored in memory and executed by the processor of load balancer 30. In other embodiments, the functions can be performed by hardware, or any combination of hardware and software. The functions can also be performed by a device that is separate from, but in communication with, load balancer 30.

At function 100, load balancer 30 receives a Uniform Resource Locator (“URL”) or other type of Web request from client computer 30. The Web request is directed to a Web site that is concurrently located on each of servers 41-45. The Web request is a request for content located on the Internet.

At function 110, load balancer 30 selects one of servers 41-45 based on known load balancing algorithms or techniques. These algorithms typically distribute URL requests or queries equitably among servers 41-45 in order to amortize load and improve availability by avoiding downed servers. The Web request is then forwarded to the selected server.

At function 120, the selected server responds to the request with Web content such as a HyperText Markup Language (“HTML”) Web page. The Web content is received by load balancer 30.

At function 130, load balancer 30 compares the Web content received from the server with the master copy of the Web content stored at load balancer 30. In one embodiment, the Web content has static content such as a Web page that does not change. In this embodiment, the comparison can be on a bit-by-bit basis to insure that the Web pages are identical.

In another embodiment, the Web content has dynamic content that changes, such as a Web page that returns a calculated price of a requested product item. In this embodiment, the static portion of the Web page can be compared on a bit-by-bit basis, and the dynamic content can be compared to a template that specifies valid ranges or possibilities of the content. For example, a template might specify that the price of a product should be between $10-$50. The comparison would verify that the price on the returned Web page is between this range, and also whether the “price” is even a number (e.g., a hacker may substitute a phrase or picture for the price).

At function 140, load balancer 30 determines whether the received Web content is valid based on the comparison at function 130. In one embodiment, the Web content is valid only if the static content is identical to the master Web content at load balancer 30 and the dynamic content falls within template specifications. If the Web content is not valid, it is likely that the server that sent that content has been hacked.

If at function 140 it is determined that the Web content is not valid, multiple actions may be taken at function 150. One action is to send an e-mail to an administrator to alert the administrator that the server has been hacked, or otherwise report the status of the server. Another action is to mark the server that sent the invalid content as “dead”, and have load balancer 30 redirect the Web request from function 100 to one of the remaining servers at function 160. All future Web requests received by load balancer 30 would then be re-balanced to exclude the dead server, until the server is corrected.

If load balancer 30 determines that the Web content is valid at function 140, the Web content is forwarded to client computer 10 at function 170. The Web content is then displayed at client computer 10 at function 180.

In one embodiment, for performance sensitive implementations, only a percentage of the traffic for each Web page is checked for validity by load balancer 30 as opposed to all of the traffic.

When updating the valid content, the load balancer should be updated first. After updating the load balancer each of the servers should be updated. For a period of time the old content and new content will be valid. After that period old content will be treated as hacked or invalid content.

As described, embodiments of the present invention checks for the validity of Web content at a load balancer in response to a Web content request.

Embodiments of the present invention provide advantages over prior art intrusion detection devices because the load balancer can transparently get valid content to a user through an alternative server when not all of servers 41-45 are hacked. In addition, embodiments of the present invention provide proactive hacked content discovery and faster hacked Web server recovery. In addition, embodiments of the present invention eliminates the need for a separate intrusion detection device by using an already existing load balancer. This reduces latency and allows networks to operate more efficiently and at lower costs.

Several embodiments of the present invention are specifically illustrated and/or described herein. However, it will be appreciated that modifications and variations of the embodiments of the present invention are covered by the above teachings and within the purview of the appended claims without departing from the spirit and intended scope of the invention.

What is claimed is:

1. A method of detecting intrusion comprising:
receiving a request for data;
sending the request to a first server of a plurality of servers;
receiving a first copy of content in response to the request; and
comparing the first copy of content to a master copy of content.

2. The method of claim 1, further comprising:
determining if the first copy is valid based on the comparison.

3. The method of claim 2, further comprising:
if it is determined that the first copy is not valid, marking the first server as dead and resending the request to a second server of the plurality of servers.

4. The method of claim 2, further comprising:
if it is determined that the first copy is not valid, sending an e-mail regarding a status of the first server.

5. The method of claim 1, wherein sending the request comprises a load balancing algorithm.

6. The method of claim 3, further comprising:
receiving a second request;
sending the second request to a third server of the plurality of servers, wherein the plurality of servers do not include the first server if the first server is marked dead.

7. The method of claim 1, wherein the request is a Uniform Resource Locator request and the first copy is an Internet Web page.

8. The method of claim 1, wherein the comparing comprises a bit-by-bit comparison of the first copy and the master copy.

9. The method of claim 1, wherein the comparing comprises a valid range evaluation of dynamic content.

10. An intrusion detection device comprising:
a processor; and
memory coupled to said memory;
wherein the memory stores a master copy of content that is stored on a plurality of servers; and
wherein the memory stores instructions which, when executed by said processor in response to receiving a request for data, cause said processor to:
send the request to a first server of the plurality of servers;
receive a first copy of content in response to the request; and
compare the first copy of content to the master copy of content.

11. The intrusion detection device of claim 10, further causing said processor to:
determine if the first copy is valid based on the comparison.

12. The intrusion detection device of claim 11, further causing said processor to:
if it is determined that the first copy is not valid, mark the first server as dead and resend the request to a second server of the plurality of servers.

13. The intrusion detection device of claim 1 1, further causing said processor to:
if it is determined that the first copy is not valid, send an e-mail regarding a status of the first server.

14. The intrusion detection device of claim 10, wherein sending the request comprises a load balancing algorithm.

15. The intrusion detection device of claim 12, further causing said processor to:
receive a second request;
send the second request to a third server of the plurality of servers, wherein the plurality of servers do not include the first server if the first server is marked dead.

16. The intrusion detection device of claim 12, wherein the request is a Uniform Resource Locator request and the first copy is an Internet Web page.

17. The intrusion detection device of claim 10, wherein the master copy of content comprises a template for dynamic content.

18. A computer readable medium having instructions stored thereon that, when executed by a processor, cause the processor, after receiving a request for data from a client computer, to:
send the request to a first server of a plurality of servers;
receive a first copy of content in response to the request; and
compare the first copy of content to a master copy of content.

19. The computer readable medium of claim 18, said instructions further causing said processor to:
determine if the first copy is valid based on the comparison.

20. The computer readable medium of claim 19, said instructions further causing said processor to:
if it is determined that the first copy is not valid, mark the first server as dead and resend the request to a second server of the plurality of servers.

21. The computer readable medium of claim 19, said instructions further causing said processor to:
if it is determined that the first copy is not valid, send an e-mail regarding a status of the first server.

22. The computer readable medium of claim 18, wherein sending the request comprises a load balancing algorithm.

23. The computer readable medium of claim 18, said instructions further causing said processor to:
receive a second request;
send the second request to a third server of the plurality of servers, wherein the plurality of servers do not include the first server if the first server is marked dead.

24. The computer readable medium of claim 18, wherein the request is a Uniform Resource Locator request and the first copy is an Internet Web page.

25. The computer readable medium of claim 18, wherein the master copy of content comprises a template for dynamic content.
